(19) United States
(12) Patent Application Publication
(10) Pub. No.: US 2025/0378641 A1
(43) Pub. Date: Dec. 11, 2025

(54) TWO-DIMENSIONAL TO THREE-DIMENSIONAL COMMUNICATION

(71) Applicant: Apple Inc., Cupertino, CA (US)

(72) Inventors: Long H Ngo, San Jose, CA (US); Jeffrey S Norris, Saratoga, CA (US); Alexandre Da Veiga, Seattle, WA (US); Sebastian P Herscher, San Francisco, CA (US)

(21) Appl. No.: 19/219,403

(22) Filed: May 27, 2025

Related U.S. Application Data
(60) Provisional application No. 63/657,636, filed on Jun. 7, 2024.

(51) Int. Cl. G06T 17/20; G06T 15/04

(52) U.S. Cl. CPC G06T 17/20; G06T 15/04

(57) ABSTRACT

Various implementations disclosed herein include devices, systems, and methods that provide a 3D representation of a user over time during live streaming. For example, a process may include obtaining sensor data depicting two-dimensional (2D) representations of an upper body of a user at multiple points in time. The process may further obtain three-dimensional (3D) information corresponding to portions of the 2D representations and predict disparities in 3D views of the upper body of the user produced using the 2D representations and the 3D information. The disparities are predicted to occur between sets of pixels of the 2D representations. The process may further generate changes to reduce the disparities such that the 3D views of the upper portion of the user with the changes reducing the disparities are presented during a communication session by a receiving device.

### CROSS-REFERENCE TO RELATED APPLICATIONS

This application claims the benefit of U.S. Provisional Application Ser. No. 63/657,636 filed Jun. 7, 2024, which is incorporated herein in its entirety.

### TECHNICAL FIELD

The present disclosure generally relates to systems, methods, and devices that provide a three-dimensional (3D) video/representation of a user over time during, for example, live streaming events.

### BACKGROUND

Existing visual communication techniques between users of devices typically involve providing a two-dimensional (2D) video of a user of a device. Existing visual communication techniques may not adequately facilitate a 3D other representation of a user with enhancements that improve the realism or other aspects of the 3D representation to provide efficient, desirable, and enhanced viewing experiences.

### SUMMARY

Various implementations disclosed herein include devices, systems, and methods that provide a 3D representation (e.g., a video) of a user upper body (e.g., a head, a head and shoulders, etc.) over time (e.g., 3D video frames) during a live streaming event between a first device and a second device. For example, a live streaming event may comprise a video call or communication between a mobile device or tablet and a head mounted device (HMD).

In some implementations, during a live streaming event, 3D information determined via an RGB stream in combination with a depth (D) stream on a mobile device (e.g., from a front facing camera) may be transmitted to an HMD. The RGB stream in combination with the depth (D) stream may depict 2D representations of an upper body of a user. Subsequently, the upper body of the user may be reconstructed as a 3D user upper body representation that may be modified to improve an appearance for 3D presentation via the HMD.

In some implementations, the user upper body is reconstructed as a 3D user upper body representation and modified on the HMD (e.g., a receiving device) such that the HMD generates the modifications and presents a view of the 3D user upper body representation using the 2D representations of the upper body of the user, 3D information, and the modifications. In some implementations, the user upper body is reconstructed as a 3D user upper body representation and modified on the mobile device (e.g., a sending device) such that the mobile device generates the modifications and transmits 3D user upper body representation to the HMD for display.

In some implementations, depth data (e.g., a distance from a camera viewpoint) may be determined via a depth sensor (e.g., RGBD). In some implementations, depth data may be determined via two RGB cameras or a single RGB camera (e.g., performing a mono image to stereo image pair conversion).

In some implementations, disparities in 3D views of an upper body of user are predicted using 2D representations of the upper body of the user and associated 3D information. The disparities may be predicted to occur between sets of pixels of the 2D representations. For example, predicting disparities may include identifying regions where a 3D view will present disparities: between sets of pixels within the 2D representations, between sets of pixels at boundaries of the 2D representations, between sets of pixels at between frames comprising 2D representations, between adjacent pixels, etc.

In some implementations, depth data may be used to directly adjust and present 2D to 3D content such as, for example, to make changes to remove pixel disparities and present a 3D view of pixels based on associated depths and the changes. In some implementations, depth data may be used to determine 3D pixel positions (e.g., a point cloud) that are subsequently used to adjust content. For example, depth data may be used to resolve or remove pixel disparities and present a 3D view of the pixels based on associated 3D positions and the changes.

In some implementations, generating changes to remove pixel disparities may include generating replacement content based on interpolation between sets of pixels to reduce (or remove) the pixel disparities. In some implementations, an interpolation process may include a multi-layer (multiresolution) interpolation process. For example, disparities between sets of pixels within a 2D representation (e.g., holes) may be mitigated using multi-resolution inpainting between each set of pixels (e.g., color and depth pixels). Likewise, a temporal smoothing process may be performed between frames to prevent popping artifacts. Additionally, an edge feathering process may be performed with respect to depth at edges or cliffs of 3D views of an upper body of a user.

In some implementations, an electronic device has a processor (e.g., one or more processors) that executes instructions stored in a non-transitory computer-readable medium to perform a method. The method performs one or more steps or processes. In some implementations, sensor data depicting 2D representations of an upper body of a user at multiple points in time is obtained. The upper body includes at least a head of the user. In some implementations, 3D information corresponding to portions of the 2D representations is obtained and disparities in 3D views of the upper body of the user produced are predicted using the 2D representations and the 3D information. The disparities are predicted to occur between sets of pixels of the 2D representations. In some implementations, changes are generated based on interpolation between the sets of pixels to reduce or remove the disparities.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates exemplary electronic devices operating in physical environments, in accordance with some implementations.

FIG. 2 illustrates an example of generating and displaying a representation of an upper body of a user, in accordance with some implementations.

FIG. 3 illustrates an example representing a process that converts a mono image into a stereo image pair, in accordance with some implementations.

FIG. 4A illustrates an exemplary view of sensor data that includes 2D representations of an upper body of a user of a device at multiple points in time, in accordance with some implementations.

FIG. 4B illustrates an exemplary view of a 3D video representation of a user upper body presented during a live streaming event between users, in accordance with some implementations.

FIG. 5 is a flowchart representation of an exemplary method that provides a 3D representation of a user upper body over time during a live streaming event between devices, in accordance with some implementations.

FIG. 6 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

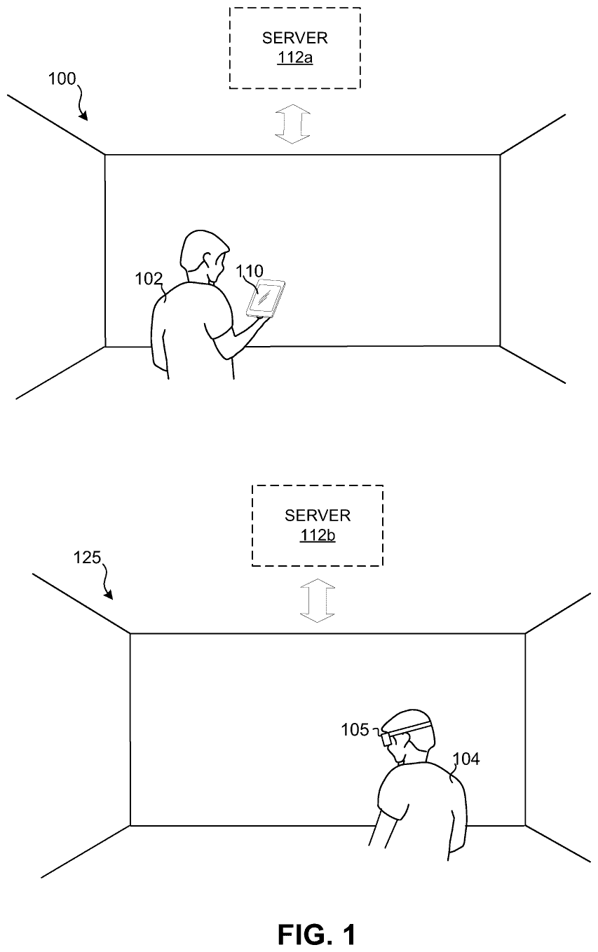

FIG. 1 illustrates an exemplary electronic device 110 operating in a physical environment 100 and an exemplary electronic device 105 operating in a physical environment 125. In the example of FIG. 1, the physical environment 100 is a room at a first location and the physical environment 125 is a room at a second (differing) location. Additionally, electronic device 110 may be in communication with a server 112a and electronic device 105 may be in communication with a server 112b. In an exemplary implementation, electronic device 105 and electronic device 110 are sharing information with server 112a and/or 112b and/or each other. The electronic devices 105 and 110 may include one or more cameras, microphones, depth sensors, or other sensors that can be used to capture information about and evaluate the physical environments 100 and 125 and the objects within it, as well as information about user 102 of electronic device 110 and user 104 of electronic device 105. The information about the physical environment 100 and 125 and/or users 102 and 104 may be used to provide visual and audio content and/or to identify the current location of the physical environment 100 and 125 and/or the location of the users 102 and 104 within the physical environment 100 and 125. In some implementations, devices 110 and 105 enable a live streaming event for providing a live visual communication session (e.g., a video call) between user 102 of device 110 and user 104 of device 105.

In some implementations, views of an extended reality (XR) environment may be provided to one or more participants (e.g., users 102 and 104 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of users 102 and 104 (e.g., an upper body portion such as, inter alia, a head, a head and shoulders, etc.) based on camera images and/or depth camera images of the users 102 and 104. Such an XR environment may include virtual content that is positioned at 3D locations relative to a 3D coordinate system (e.g., a 3D space) associated with the XR environment, which may correspond to a 3D coordinate system of the physical environment 100.

In some implementations, electronic device 105 and/or electronic device 110 may be configured provide a 3D representation of a user upper body (e.g., a head or a head and shoulders of user 102 of device 110) over time during a live streaming communication event (e.g., a video call) between user 102 of device 110 (e.g., a tablet) and user 104 of device 105 (e.g., an HMD).

In some implementations (during a live streaming communication event), an electronic device, such as a tablet, may be configured to obtain sensor data depicting 2D representations of an upper body of a user (e.g., user 102 or user 104) at multiple points in time. For example, sensor data may comprise an RGB data stream in combination with a depth (D) data stream from a front facing camera of the tablet (e.g., a sending device), mono images from the table, etc.

In some implementations, 3D information may be obtained. The 3D information may correspond to portions, such as sets of pixels, of the 2D representations. For example, 3D information may include depth information (e.g., a distance from a camera viewpoint) determined via: a depth sensor (e.g., an RGBD sensor), two RGB cameras, a single RGB camera (e.g., via a mono to stereo image pair process), etc.

In some implementations, disparities may be predicted with respect to 3D views of the upper body of the user produced using the 2D representations and the 3D information. The disparities may be predicted to occur between sets of pixels of the 2D representations. For example, predicting disparities may include identifying regions of a 3D view associated with disparities or discrepancies between sets of pixels within the 2D representations, between sets of pixels at boundaries of the 2D representations, between sets of pixels between frames comprising 2D representations, between adjacent pixels, etc.

In some implementations, replacement content (associated with resolving the disparities) may be generated based on interpolation techniques performed between sets of pixels to reduce (or remove) the disparities. For example, removing or reducing disparities between sets of pixels within 2D representations, removing or reducing disparities between sets of pixels at boundaries of 2D representations, removing or reducing disparities between sets of pixels between frames comprising 2D representations. In some implementations, an interpolation technique may include a multi-layer (multi-resolution) interpolation technique.

In some implementations, 3D views of the upper portion of the user may be presented with adjustments associated with resolving or reducing the disparities during a communication session.

In some implementations, depth information may be used directly perform the adjustments and present content (e.g., resolving pixel disparities and presenting a 3D view of pixels based on associated depths and results of resolving pixel disparities). In some implementations depth information may be used to determine 3D pixel positions (e.g., a point cloud) used to adjust content (e.g., resolving pixel disparities and presenting a 3D view of pixels based on associated 3D positions and results of resolving pixel disparities).

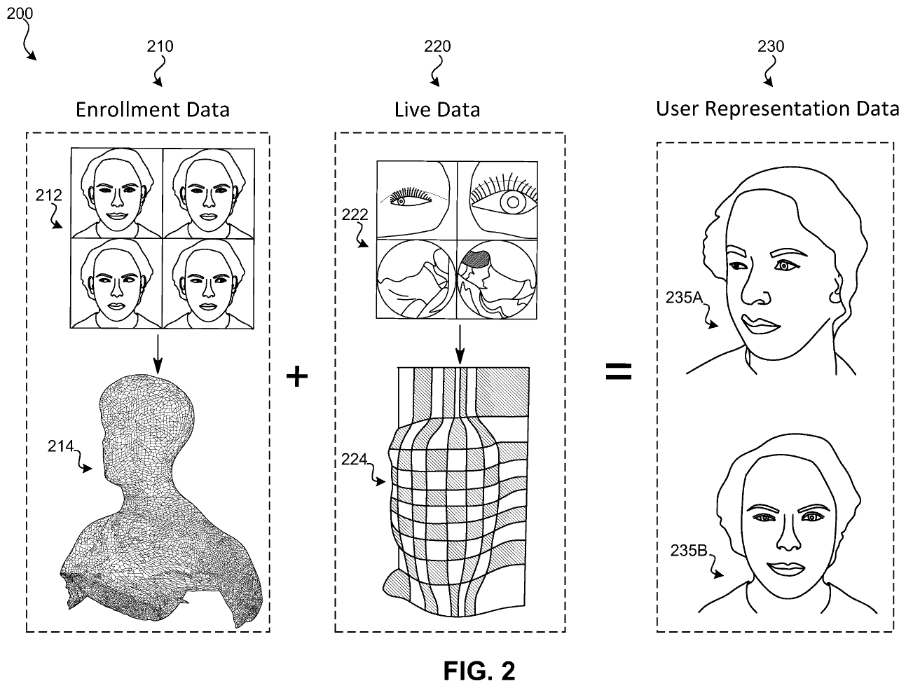

FIG. 2 illustrates an example of generating and displaying a representation of an upper body (e.g., a head, a head and shoulders, etc.) of a user (e.g., user 102 and/or user 104 of FIG. 1). In particular, FIG. 2 illustrates an example process 200 for combining enrollment data 210 (e.g., enrollment image data 212 and an enrollment 3D mesh 214) and live data 220 (e.g., live image data 222 and generated frame-specific 3D representations 224) to generate user representation data 230 (e.g., an avatar 235). In this example, the frame-specific 3D representation 224 is an RGB-D type data structure representing texture/color for pixels on a surface as well as depth values that define the distance of such points from a reference point for rendering/3D purposes.

Enrollment image data 212 includes or is based upon images of a user (e.g., user 102 and/or 104 of FIG. 1) during an enrollment process. For example, the enrollment personification may be generated as the system obtains image data (e.g., RGB images) of the user's upper body including a head, face, and shoulders while the user is providing different head poses and facial expressions. For example, the user may be told to “move your head”, “raise your eyebrows,” “smile,” “frown,” etc., in order to provide the system with a range of head/facial features for an enrollment process. An enrollment personification preview may be shown to the user while the user is providing the enrollment images to get a visualization of the status of the enrollment process. In this example, enrollment data 210 displays the enrollment personification with four different movements and/or user expressions, however, more or less or different expressions may be utilized. The predetermined 3D mesh 214 includes a plurality of vertices and polygons that may be determined at an enrollment process based on sensor data, such as RGB data and depth data.

The live image data 222 represents examples of acquired images of a user while using a device (e.g., device 105 and/or 110 of FIG. 1) such as during a live streaming event for providing a live visual communication session (e.g., a video call) between user 102 of device 110 and user 104 of device 105. In some implementations, the live image data 222 may represent images acquired while user 102 is using device 110 as illustrated in FIG. 1. For example, if the device 110 is a tablet, in one implementation, a front facing sensor(s) may capture pupillary data (e.g., eye gaze characteristic data) and facial and upper body feature data (e.g., head data, facial feature characteristic data, shoulder data, etc.). The generated frame-specific 3D representations 224 may be generated based on the obtained live image data 222.

User representation data 230 may present the 3D representation of a user at a plurality of points in time, e.g., for each frame of a live streaming event/communication session. For example, the avatar 235A (side facing upper body portion) and avatar 235B (forward facing upper body) may be updated as the system obtains and analyzes the real-time image data of the live data 220 and updates different values for the planar surface (e.g., the values for the vector points of an array for the frame-specific 3D representation 224 are updated for each acquired live image data). Likewise, the avatar 235A and avatar 235B may be updated to resolve or remove pixel disparities to present a 3D view of pixels based on associated 3D positions and changes associated with resolving the pixel disparities.

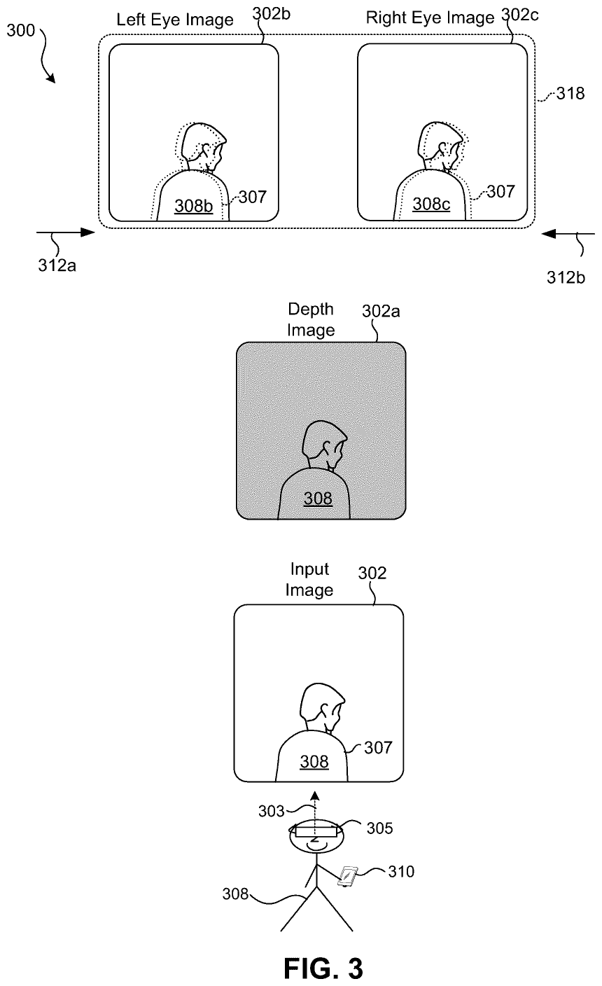

FIG. 3 illustrates an example representing a warping process 300 that converts a mono image (e.g., frames of a video stream) into a stereo image pairs, for example, by generating a left eye view (output) image 302b and right eye view (output) image 302c from a (mono) input image 302 associated with a center viewpoint 303 of a user 308 with respect to a device 305 and/or a device 310 displaying the input image 302, in accordance with some implementations. The input image 302 may comprise, inter alia, 2D representation of an upper body (e.g., a head, a head and shoulders, etc.) of user 308. The input image 302 may include appearance values such as color values located at pixel positions.

The viewpoint-based warping process 300 may include determining a depth image 302a (e.g., a low resolution 3-dimensional (3D) model illustrating user 308) that includes depth values at original pixel positions that are mapped to a subset of the pixel positions of the input image 302. Depth image 302a includes a coordinate mapping to map the original pixel positions to corresponding pixel positions in the input image 302.

Left eye view image 302b corresponds to a left eye viewpoint of input image 302 and may be generated by determining a first set of altered pixel positions for the depth values (for the left eye viewpoint) and identifying appearance (e.g., color) values for the first set of altered pixel positions based on the coordinate mapping (of the depth image 302a) and the input image 302. The left eye view image 302b represents a warped view 308b of the user 308 located at a first position (e.g., shifted horizontally in a direction 312a) differing from an original position 307 of the user 308 in the original input image 303.

Right eye view image 302c corresponds to a right eye viewpoint of the input image 302 and may be generated by determining a second set of altered pixel positions for the depth values (e.g., for the right eye viewpoint) and identifying appearance (e.g., color) values for the second set of altered pixel positions based on the coordinate mapping (of the depth image 302a) and the input image 302. The right-eye view image 302c represents a warped view 308c of the user 308 located at a second position (e.g., shifted horizontally in a direction 312b) differing from the original position 307 of the user 308 in the original input image 302. The first position represents the user 308 at a different location within left eye image version 302a than the second position within right eye image version 302b.

Therefore, when viewed via an HMD, the combination of left eye image version 302b and right eye image version 302c form a stereo output image pair 318 depicting a 3D video/representation of an upper body of user 308 for viewing on a stereoscopic display of a device such an HMD. Likewise, upper body of user 308 may be updated to resolve or remove pixel disparities to present a 3D view of pixels based on associated 3D positions and changes associated with resolving the pixel disparities.

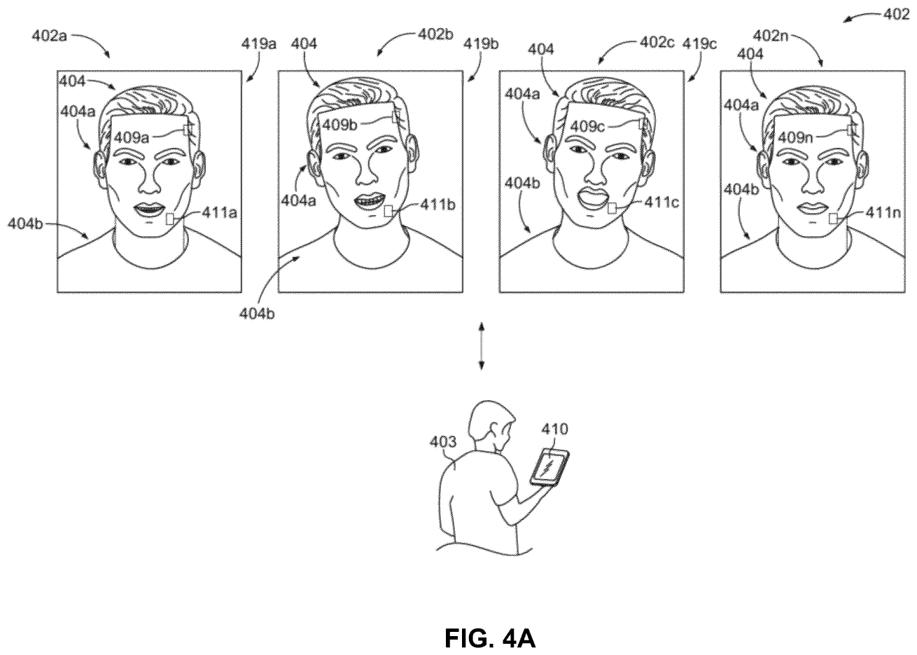

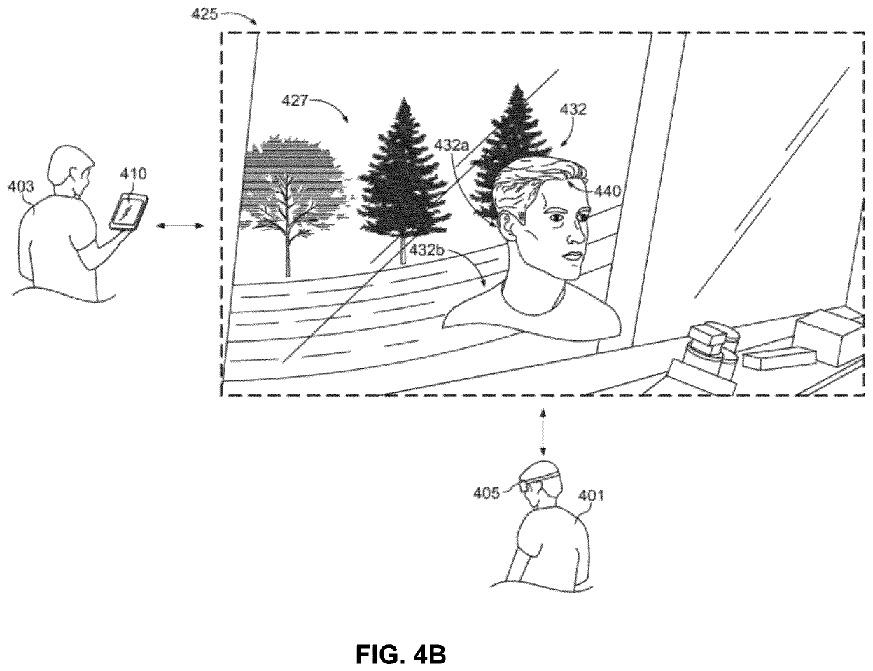

FIG. 4A illustrates an exemplary view of sensor data that includes 2D representations 402a, 402b, 402c . . . 402n (e.g., frames of a 2D video stream 402 associated with a live streaming event) of an upper body 404 comprising a head 404a and shoulders 404b of a user 403 of a device 410 (e.g., a tablet) at multiple points in time. For example, a live streaming event may be a video call or communication between user 403 of device 410 and a user of an HMD (e.g., user 104 of HMD 105 as described with respect to FIG. 4B, infra).

In some implementations, sensor data may comprise an RGB data stream in combination with a depth (D) data stream from a front facing camera of device 410 (e.g., a sending device), mono images from device 410, etc.

In some implementations, 3D information corresponds to portions (e.g., sets of pixels) of 2D representations 402a, 402b, 402c . . . 402n. 3D information may include depth information (e.g., a distance from a camera viewpoint) that is determined via a depth sensor (e.g., an RGBD sensor). Likewise, 3D information may include depth information (e.g., depth image 302a as described with respect to FIG. 3, supra) determined via a single RGB camera (e.g., via a mono to stereo image pair process), via two RGB cameras, etc.

In some implementations, disparities may be predicted with respect to subsequent 3D views of upper body 404 of the user (e.g., a 3D video representation 432 as described with respect to FIG. 4B, infra) using 2D representations 402a, 402b, 402c . . . 402n and 3D information. The disparities may be predicted to occur between sets of pixels of 2D representations 402a, 402b, 402c . . . 402n. For example, predicting disparities may include identifying regions of a 3D view associated with disparities or discrepancies between sets of pixels within the 2D representations 402a, 402b, 402c . . . 402n. For example, it may be predicted that a disparity(s) may occur in regions 411a . . . 411n located between sets of pixels (e.g., a hole or empty space occurring between pixels representing facial skin of the user) of the 2D representations 402a, 402b, 402c . . . 402n. Likewise, it may be predicted that a disparity(s) may occur in regions 409a . . . 409n located between sets of pixels at a boundary area of the 2D representations 402a, 402b, 402c . . . 402n such as at the edge at a hairline of the user. Discrepancies or disparities may further be predicted to occur between sets of pixels between frames (e.g., within regions 419a . . . 419n between any of 2D representations 402a, 402b, 402c . . . 402n).

In some implementations, replacement content (e.g., pixels) for resolving the disparities (e.g., within region 409a . . . 409n, regions 411a . . . 411n, and/or regions 419a . . . 419n) may be generated based on interpolation techniques (e.g., multi-level interpolation) performed between the sets of pixels to reduce or remove the disparities. For example, replacement content may be utilized for removing or reducing disparities between sets of pixels (e.g., holes or empty spaces occurring within regions 411a . . . 411n) within any of 2D representations 402a, 402b, 402c . . . 402n, removing or reducing disparities between sets of pixels at boundaries (e.g., within regions 409a . . . 409n) of 2D representations 402a, 402b, 402c . . . 402n, removing or reducing disparities between frames (e.g., within regions 419a . . . 419n) comprising 2D representations 402a, 402b, 402c . . . 402n.

FIG. 4B illustrates an exemplary view 425 of a 3D video representation 432 (at a single point in time) of a user upper body comprising a head 432a and shoulders 432b of a user 403 of a device 410 (e.g., a tablet) presented during a live streaming event (e.g., a communication session) between user 403 of device 410 and a user 401 of an HMD 405. Exemplary view 425 is a view of 3D video representation 432 (e.g., representing user 403) generated from 2D representations 402a, 402b, 402c . . . 402n (of FIG. 4A) of device 410 being presented to user 401 via HMD 405. The view of 3D video representation 432 being presented to user 401 via HMD 405 additionally includes a background 427 (e.g., passthrough video that includes a window, desk, and trees) at a location of user 401 such that 3D video representation 432 is positioned/presented with respect to background 427.

In some implementations, 3D video representation 432 may be presented with adjustments (e.g., replacement content such as, inter alia, pixels as described with respect to FIG. 4A, supra) associated with resolving or reducing disparities (e.g., disparities between pixels in color and depth space) occurring during the live streaming event to create a visually appealing version of 3D video representation 432.

In some implementations, depth information may be used directly to perform the adjustments and present 3D video representation 432 (e.g., resolving pixel disparities and presenting a 3D view of pixels (forming 3D video representation 432) based on associated depths and results of resolving pixel disparities). In some implementations depth information may be used to determine 3D pixel positions (e.g., a point cloud) used to adjust content forming 3D video representation 432 (e.g., resolving pixel disparities and presenting a 3D view of pixels based on associated 3D positions and results of resolving pixel disparities).

In some implementations, HMD 405 (e.g., a receiving device) may generate the adjustments and present 3D video representation 432 using 2D representations 402a, 402b, 402c . . . 402n (of FIG. 4A), 3D information such as depth, and the adjustments. In some implementations, device 410 (e.g., a sending device) may generate the adjustments and transmit 2D representations 402a, 402b, 402c . . . 402n (of FIG. 4A), 3D information such as depth, and the adjustments to the HMD 405 for display. Alternatively, device 410 may generate the adjustments using 2D representations 402a, 402b, 402c . . . 402n and 3D information such as depth to generate a stereo image pair providing 3D video representation 432 for transmission to HMD 405 for representation.

3D video representation 432 being presented with adjustments resolves or reduces disparities such that holes/empty spaces or missing pixel information between set of pixels are mitigated. Likewise, an edge feathering process may be performed with respect to depth to mitigate depth type disparities associated with blending or blurring edges of 3D video representation 432 to provide a smooth transition with respect to portions (e.g., portion 440 at a hairline of 3D video representation 432). In some implementations, a temporal smoothing process may be performed between frames to smooth frame to frame transitions and prevent popping artifacts.

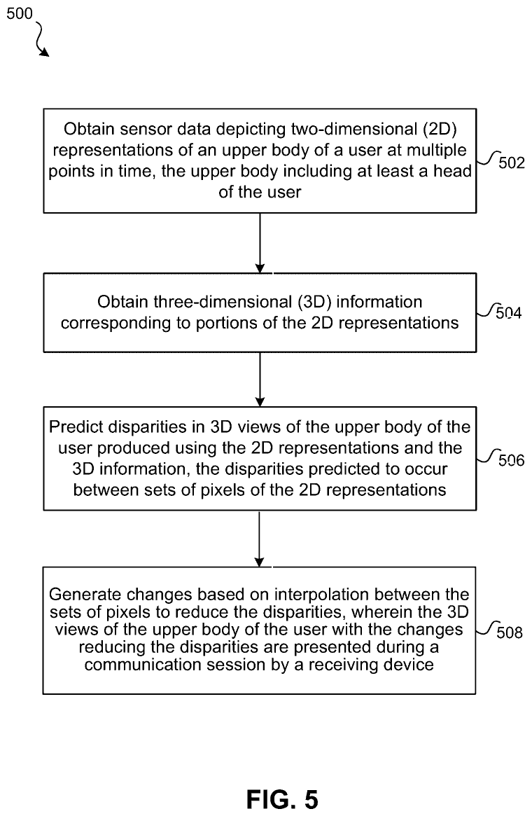

FIG. 5 is a flowchart representation of an exemplary method 500 that provides a 3D representation of a user upper body over time during a live streaming event between devices, in accordance with some implementations. In some implementations, the method 500 is performed by a device, such as a mobile device, desktop, laptop, HMD, or server device (e.g., device 110 of FIG. 1). In some implementations, the device has a screen for displaying images and/or a screen for viewing stereoscopic images such as a head-mounted display (HMD such as e.g., device 105 of FIG. 1). In some implementations, the method 500 is performed by processing logic, including hardware, firmware, software, or a combination thereof. In some implementations, the method 500 is performed by a processor executing code stored in a non-transitory computer-readable medium (e.g., a memory). Each of the blocks in the method 500 may be enabled and executed in any order.

At block 502, the method 500 obtains sensor data depicting 2D representations (e.g., 2D representations 402a, 402b, 402c . . . 402n as described with respect to FIG. 4A) of an upper body of a user at multiple points in time. The upper body (e.g., upper body 404 as described with respect to FIG. 4A) of the user may include a head of the user, a head and shoulders of the user, etc.

At block 504, the method 500 obtains 3D information (e.g., depth information such as depth image 302a as illustrated in FIG. 3) corresponding to portions, such as pixels, of the 2D representations.

In some implementations, the electronic device is a receiving device (e.g., an HMD) and the 3D information comprises depth data determined via two RGB streams in combination with two depth (D) streams from two front facing cameras of a sending device (e.g., a tablet).

In some implementations, the electronic device is a receiving device (e.g., an HMD) and the 3D information comprises depth data determined via an RGB stream in combination with a depth (D) stream from a front facing camera of a sending device.

In some implementations, the electronic device is a sending device and the 3D information comprises depth data determined via two RGB streams in combination with two depth (D) streams from a front facing camera of the electronic device.

In some implementations, the electronic device is a sending device and wherein the 3D information comprises depth data determined via an RGB stream in combination with a depth (D) stream from a front facing camera the electronic device.

In some implementations, the 3D information comprises depth information (distance from camera viewpoint) determined from a depth sensor (e.g., RGBD).

In some implementations, the 3D information comprises depth information determined from two RGB cameras.

In some implementations, the 3D information comprises depth information determined from a single RGB camera for providing a mono to stereo view.

At block 506, the method 500 predicts disparities in 3D views of the upper body of the user produced using the 2D representations and the 3D information. The disparities are predicted to occur between sets of pixels of the 2D representations.

In some implementations, the disparities are predicted to occur between the sets of pixels within the 2D representations. For example, the disparities may be predicted to occur at empty spaces between the sets of pixels.

In some implementations, the disparities are predicted to occur between the sets of pixels at boundaries (e.g., edges or boundaries) of the 2D representations.

In some implementations, the disparities are predicted to occur between the sets of pixels between frames (e.g., frame-to-frame disparities) comprising the 2D representations.

At block 508, the method 500 generates changes (e.g., added/replacement content) based on interpolation between the sets of pixels to reduce (or remove) the disparities. In some implementations, the 3D views of the upper body of the user with the changes reducing the disparities are presented during a communication session by a receiving device.

In some implementations, the 3D information comprises depth information used to directly generate the changes and present the 3D views with the changes during the communication session. (e.g., make changes to remove empty spaces and present a 3D view of the pixels based on their depths and the changes).

In some implementations, the 3D information comprises depth information used to determine 3D pixel positions (e.g., a point cloud) used to present the 3D views of the upper body of the user with the changes. (e.g., make changes to remove empty spaces and present a 3D view of the pixels based on associated 3D positions and the changes).

In some implementations, the changes comprise replacement content.

In some implementations, reducing the disparities comprises removing the disparities.

In some implementations, the interpolation comprises multilayer/multi-resolution interpolation.

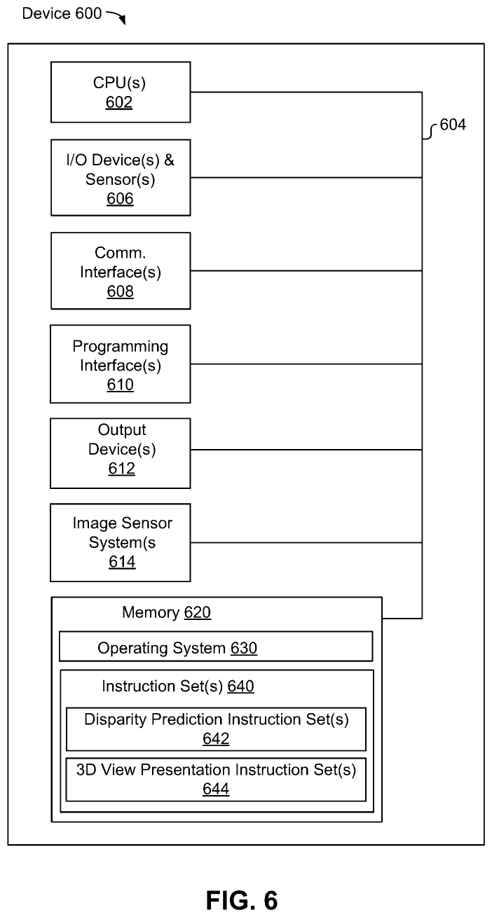

FIG. 6 is a block diagram of an example device 600. Device 600 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 600 includes one or more processing units 602 (e.g., microprocessors, ASICs, FPGAs, GPUS, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 610, output devices (e.g., one or more displays) 612, one or more interior and/or exterior facing image sensor systems 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more output device(s) 612 include one or more displays configured to present a view of a 3D environment to the user. In some implementations, the one or more displays are configured to present a view of a physical environment, a graphical environment, an extended reality environment, etc. to the user. In some implementations, the one or more displays are configured to present content (determined based on a determined user/object location of the user within the physical environment) to the user. In some implementations, the one or more displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 600 includes a single display. In another example, the device 600 includes a display for each eye of the user.

In some implementations, the one or more output device(s) 612 include one or more audio producing devices. In some implementations, the one or more output device(s) 612 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 612 may additionally or alternatively be configured to generate haptics.

In some implementations, the one or more image sensor systems 614 are configured to obtain image data that corresponds to at least a portion of the physical environment 100. For example, the one or more image sensor systems 614 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 614 further include illumination sources that emit light, such as a flash. In various implementations, the one or more image sensor systems 614 further include an on-camera image signal processor (ISP) configured to execute a plurality of processing operations on the image data.

In some implementations, the device 600 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 600 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 600.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 includes a non-transitory computer readable storage medium.

In some implementations, the memory 620 or the non-transitory computer readable storage medium of the memory 620 stores an optional operating system 630 and one or more instruction set(s) 640. The operating system 630 includes procedures for handling various basic system services and for performing hardware dependent tasks. In some implementations, the instruction set(s) 640 include executable software defined by binary information stored in the form of electrical charge. In some implementations, the instruction set(s) 640 are software that is executable by the one or more processing units 602 to carry out one or more of the techniques described herein.

The instruction set(s) 640 includes a disparity prediction instruction set 642 and a 3D view presentation instruction set 644. The instruction set(s) 640 may be embodied as a single software executable or multiple software executables.

The disparity prediction instruction set 642 is configured with instructions executable by a processor to predict disparities in 3D views of upper body of user produced using 2D representations and 3D information.

3D view presentation instruction set 644 is configured with instructions executable by a processor to present 3D views of the upper body of the user with changes that reduce disparities during a communication session.

Although the instruction set(s) 640 are shown as residing on a single device, it should be understood that in other implementations, any combination of the elements may be located in separate computing devices. Moreover, FIG. 6 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor:
obtaining sensor data depicting two-dimensional (2D) representations of an upper body of a user at multiple points in time, the upper body including at least a head of the user;
obtaining three-dimensional (3D) information corresponding to portions of the 2D representations;
predicting disparities in 3D views of the upper body of the user produced using the 2D representations and the 3D information, the disparities predicted to occur between sets of pixels of the 2D representations; and
generating changes to reduce the disparities, wherein the 3D views of the upper body of the user with the changes reducing the disparities are presented during a communication session by a receiving device.

2. The method of claim 1, wherein the disparities are predicted to occur between the sets of pixels within the 2D representations.

3. The method of claim 1, wherein the disparities are predicted to occur between the sets of pixels at boundaries of the 2D representations.

4. The method of claim 1, wherein the disparities are predicted to occur between the sets of pixels between frames comprising the 2D representations.

5. The method of claim 1, wherein the electronic device is the receiving device, and wherein the 3D information comprises depth data determined via two RGB streams in combination with two depth (D) streams from two front facing cameras of a sending device.

6. The method of claim 1, wherein the electronic device is the receiving device, and wherein the 3D information comprises depth data determined via an RGB stream in combination with a depth (D) stream from a front facing camera of a sending device.

7. The method of claim 1, wherein the electronic device is a sending device, and wherein the 3D information comprises depth data determined via two RGB streams in combination with two depth (D) streams from a front facing camera of a front facing camera of the electronic device.

8. The method of claim 1, wherein the electronic device is a sending device, and wherein the 3D information comprises depth data determined via an RGB stream in combination with a depth (D) stream from a front facing camera the electronic device.

9. The method of claim 1, wherein the 3D information comprises depth information determined from a depth sensor.

10. The method of claim 1, wherein the 3D information comprises depth information determined from two RGB cameras.

11. The method of claim 1, wherein the 3D information comprises depth information determined from a single RGB camera for providing a mono to stereo view.

12. The method of claim 1, wherein the 3D information comprises depth information used to directly generate the changes and present the 3D views with the changes during the communication session.

13. The method of claim 1, wherein the 3D information comprises depth information used to determine 3D pixel positions used to present the 3D views of the upper body of the user with the changes.

14. The method of claim 1, wherein the changes comprise replacement content.

15. The method of claim 1, wherein reducing the disparities comprises removing the disparities.

16. The method of claim 1, wherein the interpolation comprises multilayer interpolation.

17. The method of claim 1, wherein the upper body comprises a head of the user.

18. The method of claim 1, wherein said generating the changes is based on interpolation between the sets of pixels to reduce the disparities.

19. A system comprising:
a processor;
a computer readable medium storing instructions that when executed by the processor cause the processor to perform operations comprising:
obtaining sensor data depicting two-dimensional (2D) representations of an upper body of a user at multiple points in time, the upper body including at least a head of the user;
obtaining three-dimensional (3D) information corresponding to portions of the 2D representations;
predicting disparities in 3D views of the upper body of the user produced using the 2D representations and the 3D information, the disparities predicted to occur between sets of pixels of the 2D representations; and
generating changes to reduce the disparities, wherein the 3D views of the upper body of the user with the changes reducing the disparities are presented during a communication session by a receiving device.

20. A non-transitory computer-readable medium comprising instructions that when executed by a processor cause the processor to perform operations comprising:
obtaining sensor data depicting two-dimensional (2D) representations of an upper body of a user at multiple points in time, the upper body including at least a head of the user;
obtaining three-dimensional (3D) information corresponding to portions of the 2D representations;
predicting disparities in 3D views of the upper body of the user produced using the 2D representations and the 3D information, the disparities predicted to occur between sets of pixels of the 2D representations; and
generating changes to reduce the disparities, wherein the 3D views of the upper body of the user with the changes reducing the disparities are presented during a communication session by a receiving device.
